(19) United States
(12) Patent Application Publication
(10) Pub. No.: US 2024/0398036 A1
(43) Pub. Date: Dec. 5, 2024

(54) AN AEROSOL-GENERATING SYSTEM AND METHOD OF AEROSOL PRODUCTION WITH ADAPTIVE POWER CONTROL

(71) Applicant: Philip Morris Products S.A., Neuchatel (CH)

(72) Inventors: Stéphane BILAT, Cortaillod (CH); Gregory André CRISTIAN, Saint-Sulpice (CH)

(73) Assignee: Philip Morris Products S.A., Neuchatel (CH)

(21) Appl. No.: 18/697,080

(22) PCT Filed: Oct. 6, 2022
(86) PCT No.: PCT/EP2022/077819

§ 371 Date: Mar. 29, 2024

(30) Foreign Application Priority Data
Oct. 7, 2021 (EP) 21201407.0

(51) Int. Cl. A24F 40/57; A24F 40/10; A24F 40/20; A24F 40/51; H05B 1/02

(52) U.S. Cl. CPC A24F 40/57; A24F 40/10; A24F 40/20; A24F 40/51; H05B 1/0244

(57) ABSTRACT

An aerosol-generating system is provided, including: an air inlet and outlet; an air flow passage extending between the inlet and outlet; a heating element to heat an aerosol-forming substrate; a sensor assembly in communication with the passage to measure a pressure or flow rate within the passage; and a controller to detect a start of a puff, read the pressure or flow rate, and control a supply of power in a first mode in response to the start of the puff and dependent on both a time since the start of the puff and the pressure or flow rate read by the controller following the start, and the controller includes a look-up table including power values corresponding to a pressure range or flow rate range and a time range since the start, the controller using in the first mode the table to control the supply of power.

The present invention relates to aerosol-generating systems and methods for controlling aerosol production. In particular, the invention relates to the control of power in aerosol-generating systems on which a user puffs to draw aerosol out of the system and methods for controlling the supply of power in such systems.

In many aerosol-generating systems for generating an aerosol for user inhalation, an electrically operated heating element is used to heat an aerosol-forming substrate to generate the aerosol. Such aerosol-generating systems include electronic cigarettes or heated tobacco systems, which generate aerosol on-demand for the purpose of inhalation. The on-demand generation of aerosol is typically initiated by a user puffing on the aerosol-generating system. When a user takes a puff, air is drawn through the aerosol-generating system and the aerosol is delivered to the user.

Users of this type of aerosol-generating system may be past or current users of conventional lit-end cigarettes. In a conventional lit-end cigarette, increased puffing strength by the user on the cigarette results in a greater production of aerosol. In many electrically heated aerosol-generating systems however, an increase in puffing strength does not increase aerosol production in a proportional way. An increase in puffing strength may result in increased airflow through the system, which in turn cools the heater, decreasing in aerosol production. But increased airflow may also increase extraction of aerosol from the system by entraining more aerosol droplets into the airflow. The exact relationship between puffing strength and aerosol volume can be complex and depends on the design of the system.

Different users may exhibit different puff behaviours when using an aerosol-generating system. A single user may also exhibit different puff behaviours at different times. Puff behaviours may be characterised by a combination of the puff strength or pressure, and the puff duration. As a result of the relationship between puffing strength and aerosol volume, an aerosol-generating system set up to provide a satisfying experience for one puffing behaviour may not provide a satisfying experience for others.

It would therefore be desirable to provide an aerosol-generating system and method that emulates the aerosol delivery experience of conventional lit-end cigarettes in terms of aerosol volume and adapts to suit the puffing behaviour of different users or of a different puffing behaviour of a single user at different times.

In a first aspect of the disclosure, there is provided an aerosol-generating system. The aerosol-generating system may comprise: an air inlet and an air outlet; an air flow passage extending between the air inlet and the air outlet; a heating element for heating an aerosol-forming substrate; and a sensor assembly in communication with the air flow passage, the sensor assembly being configured to measure a pressure or a flow rate within the airflow passage. The aerosol-generating system may comprise a controller configured to read the pressure or the flow rate measured by the sensor assembly, detect a start of a puff, and control a supply of power to the heating element in a first mode in response to the start of the puff. Preferably, the controller is configured to detect a start of a puff and an end of a puff, read the pressure or the flow rate measured by the sensor assembly, and control a supply of power to the heating element in a first mode in response to the start of the puff and before the end of the puff. The controller may control the supply of power to the heating element in the first mode dependent on both the time since the start of the puff and the pressure or the flow rate read by the controller following the start of the puff. Preferably the controller controls the supply of power to the heating element in the first mode, and the controller determines an amount of power to supply to the heating element at regular time intervals in the first mode, wherein the amount of power dependent on both the time since the start of the puff and the pressure or the flow rate read by the controller at each regular time interval.

Advantageously, this allows for adaptability of the aerosol-generation to better suit different puffing behaviours. Such adaptability may then better emulate the aerosol delivery experience of conventional lit-end cigarettes for users irrespective of differing puffing behaviours.

Preferably the controller is further configured in the first mode to read the pressure or the flow rate from the sensor assembly at regular time intervals. Advantageously, this allows for regular adjustment of the supply of power to the heating element in response to changes in pressure during a puff. The duration of the regular time intervals may be between 1 millisecond and 1000 milliseconds. Preferably, the duration of the regular time intervals is between 2 milliseconds and 500 milliseconds, more preferably, the duration of the regular time intervals is between 5 milliseconds and 250 milliseconds, more preferably still, the duration of the regular time intervals is between 10 milliseconds and 100 milliseconds, more preferably still, the duration of the regular time intervals is between 20 milliseconds and 60 milliseconds, and more preferably still, the duration of the regular time intervals is substantially equal to 40 milliseconds.

The controller may comprises a computer readable memory storing a look-up table. The look-up table may comprise a plurality of power values. Each power value may correspond to a pressure range or a flow rate range, and a time range since the start of a puff. The controller may be further configured in the first mode to use the look-up table to control the supply of power to the heating element. Advantageously, such a look-up table may provide aerosol-generation that adapts to the puffing behaviour of the user. The time ranges may be of equal length. The time ranges may be between 0 milliseconds and 2000 milliseconds. Preferably, the lengths of the time ranges may be between 10 milliseconds and 1500 milliseconds. More preferably, the lengths of the time ranges may be between 50 milliseconds and 1200 milliseconds. More preferably still, the lengths of the time ranges may be between 200 milliseconds and 1000 milliseconds. More preferably still, the lengths of the time ranges may be between 600 milliseconds and 800 milliseconds. The time ranges may be of different lengths. This may mean that the time ranges are best suited to typical variations in pressure during a puff. The number of time ranges in the look-up table may be between 2 and 1000. Preferably, the number of time ranges in the look-up table is between 2 and 100, more preferably between 2 and 50, even more preferably between 2 and 20. More preferably still, the number of time ranges in the look-up table is between 2 and 10, more preferably between 4 and 8, and even more preferably between 5 and 7. In aspects of the disclosure in which pressure ranges or flow rates are used in the look-up table, the pressure ranges or the flow rate ranges may be of substantially equal magnitude. Alternatively, the pressure ranges or the flow rate ranges may be of different magnitudes. This may mean that the pressure ranges or the flow rate ranges are better suited to typical variations in pressure during a puff. The number of pressure ranges or the flow rate ranges in the look-up table may be between 2 and 1000, preferably between 2 and 100, more preferably between 2 and 50, more preferably still, between 2 and 20, more preferably still between 2 and 15, more preferably still between 4 and 10, and most preferably between 7 and 9.

The supply of power to the heating element in the first mode may be dependent on a difference between a reference pressure or a reference flow rate, and the pressure or the flow rate read by the controller. The controller may detect the start of a puff when the difference between the reference pressure or the reference flow rate, and the pressure or the flow rate read by the controller exceeds a first threshold pressure or a first threshold flow rate. Advantageously, this ensures accurate detection of a puff, and eliminates any false puffs being detected by smaller variations in ambient pressure. The first threshold pressure or the first threshold flow rate may be pre-determined. The first threshold pressure or the first threshold flow rate may be stored in the computer readable memory. The first threshold pressure or the first threshold flow rate may be calculated as a proportion or as a multiple of the reference pressure or the reference flow rate.

Preferably, the reference pressure or the reference flow rate is calculated by the controller as a rolling average of an integer number of pressure values or flow rate values read by the controller preceding the detection of the start of the puff. Advantageously, this ensures that suitable power is supplied to the heating element, regardless of variations in ambient pressure or the ambient pressure at which the system is used. Additionally, this ensures suitable power is supplied to the heating element, even in the event a zero error or systematic error is present in the pressure read by the controller from the sensor assembly.

Preferably, the controller is further configured to control a supply of power to the heating element in a second mode, wherein the supply of power to the heating element in the second mode is independent of at least one of the measured time since the start of a puff, and the pressure or the flow rate read by the controller. Advantageously, this may ensure consistency in aerosol generation. It may also or alternatively act to counterbalance the thermal inertia of the system. The supply of power to the heating element in the second mode may be independent of both the measured time since the start of a puff and the pressure or the flow rate read by the controller. In the second mode the power supplied to the heating element may be constant for the duration of a puff.

The controller may be further configured to control the supply of power to the heating element in either the first mode or the second mode dependent on a number of puffs since one of: the aerosol-generating system being reset, the aerosol-generating system being switched on, or the heating element cooling down to an ambient temperature after at least one puff. The controller may be configured to control the supply of power to the heating element in either the first mode or the second mode dependent on a cumulative puffing time since one of: the aerosol-generating system being reset, the aerosol-generating system being switched on, or the heating element cooling down to an ambient temperature after at least one puff. The controller may be configured to control the supply of power to the heating element in either the first mode or the second mode dependent on a cumulative energy supplied to the heating element since one of: the aerosol-generating system being reset, the aerosol-generating system being switched on, or the heating element cooling down to an ambient temperature after at least one puff. The controller may be configured to control the supply of power to the heating element in either the first mode or the second mode dependent on a combination of at least two of: a cumulative energy supplied to the heating element, a cumulative puffing time and a number of puffs, since one of: the aerosol-generating system being reset, the aerosol-generating system being switched on, or the heating element cooling down to an ambient temperature after at least one puff. The controller may be configured to control the supply of power to the heating element in either the first mode or the second mode dependent on a cumulative energy supplied to the heating element within a specified time interval prior to the start of the puff. The controller may be configured to control the supply of power to the heating element in either the first mode or the second mode dependent on a cumulative heating time of the heating element within a specified time interval prior to the start of the puff. Advantageously, any of these control strategies may be utilised to increase the overall power delivery to the heating element for the first few puffs to warm-up the system.

Preferably, the aerosol-generating system comprises an aerosol generating device. The aerosol generating device may comprise a receptacle configured to receive an aerosol-generating article or a cartridge containing the aerosol-forming substrate. The aerosol generating article or the cartridge may be coupled to and uncoupled from the aerosol-generating device.

The controller may be further configured to control the supply of power to the heating element in either the first mode or the second mode dependent on a number of puffs since the aerosol-generating article or the cartridge has been coupled to the aerosol-generating device. The controller may be configured to control the supply of power to the heating element in either the first mode or the second mode dependent on a cumulative puffing time since the aerosol-generating article or the cartridge has been coupled to the aerosol-generating device. Either of these control strategies may be utilised to increase the overall power delivery for the first few puffs to warm-up the system.

The heating element may be a resistive heating element. The resistive heating element may take the form of a mesh, array or fabric of electrically conductive filaments. An aerosol-generating article containing the aerosol-forming substrate may supply an aerosol-forming liquid to the mesh.

The controller may be further configured to detect an adverse condition at the heating element, such as when insufficient aerosol-forming liquid is supplied to the heating element.

The controller may be configured to determine a maximum electrical resistance of the heating element during each puff; calculate a rolling average value of maximum electrical resistance of the heating element for n preceding heating cycles, wherein n is an integer greater than 1; compare the electrical resistance of the heating element with the calculated rolling average value; determine an adverse condition when the electrical resistance is greater than that the rolling average value by more than a resistance threshold value, said resistance threshold value being stored in the computer readable memory. The controller may be configured to determine a first derivative or a second derivative of the electrical resistance with respect to time; and determine an adverse condition when the first derivative or the second derivative exceeds or is equal to a first or second derivative threshold value, with the first derivative or the second derivative threshold value being stored in the computer readable memory. For either configuration, the resistance threshold value or the first derivative or the second derivative threshold value may be dependent on whether the supply of power to the heating element is controlled in the first mode or the second mode. Preferably, the resistance threshold value or the first derivative or the second derivative threshold value is dependent on the power supplied to the heating element. A resistance threshold value or a first derivative or a second derivative threshold value may be calculated for each of the power values of the plurality of power values stored in the computer readable memory. A resistance threshold value or a first derivative or a second derivative threshold value corresponding to each of the power values of the plurality of power values stored in the computer readable memory may be stored in the computer readable memory. Advantageously, adjusting such threshold values will adjust the sensitivity to adverse conditions at the heating element to the power delivered to the mesh over time and pressure or flow rate, and so will reduce possible harmful components being generated in the aerosol. The controller may determine an adverse condition when the resistance threshold value or the first derivative or the second derivative threshold value is exceeded during two consecutive puffs by the user. In this case, the resistance threshold value or the first derivative or the second derivative threshold value may be adjusted after the resistance threshold value or the first derivative or the second derivative threshold value is first exceeded during a puff by the user.

In a second aspect of the disclosure, there is provided a method of aerosol production in an aerosol generating system. The system may comprise: an air flow passage extending between an air inlet and an air outlet; a heating element for heating an aerosol-forming substrate; a sensor assembly in communication with the air flow passage; and a controller comprising a computer readable memory. The method may comprise in a first mode: detecting a start of a puff, reading an output from the sensor assembly to determine a pressure or a flow rate in the airflow passage, and supplying the heating element with power dependent on both the time since the start of the puff and the pressure or the flow rate in the airflow passage.

Preferably, in the first mode the output from the sensor assembly is read at regular time intervals.

In the first mode, the supply of power to the heating element may be dependent on the difference between a reference pressure or a reference flow rate and the pressure or the flow rate in the airflow passage.

The method may further comprise in the first mode: selecting a power value from a look up table stored in the computer readable memory based on the pressure or the flow rate in the airflow passage and a time since the start of the puff. The look-up table may comprise a plurality of power values, each power value corresponding to a pressure range or a flow rate range, and a time range since the start of the puff. The method may comprise suppling the heating element with power based on the selected power value.

The method may comprise the controller reading an output from the sensor assembly to determine a pressure or a flow rate in the airflow passage. The method may comprise detecting the start of a puff when the difference between the reference pressure or the reference flow rate, and the pressure or the flow rate in the airflow passage exceeds a first threshold pressure or a first threshold flow rate. The reference pressure or the reference flow rate may be calculated by the controller as a rolling average of an integer number of pressure values or flow rate values in the airflow passage preceding the detection of the start of the puff.

The method may comprise controlling the supply of power to the heating element in a second mode. The supply of power to the heating element in the second mode may be independent of at least one of the measured time since the start of a puff and the pressure or the flow rate in the airflow passage. In the second mode the power supplied to the heating element may be constant for the duration of a puff.

The method may comprise controlling the supply of power to the heating element in either the first mode or the second mode dependent on a number of puffs since one of: the aerosol-generating system being reset, the aerosol-generating system being switched on, or the heating element cooling down to an ambient temperature after at least one puff. The method may comprise controlling the supply of power to the heating element in either the first mode or the second mode dependent on a cumulative puffing time since one of: the aerosol-generating system being reset, the aerosol-generating system being switched on, or the heating element cooling down to an ambient temperature after at least one puff. The method may comprise controlling the supply of power to the heating element in either the first mode or the second mode dependent on a cumulative energy supplied to the heating element since one of: the aerosol-generating system being reset, the aerosol-generating system being switched on, or the heating element cooling down to an ambient temperature after at least one puff. The method may comprise controlling the supply of power to the heating element in either the first mode or the second mode dependent on a combination of at least two of: a cumulative energy supplied to the heating element, a cumulative puffing time and a number of puffs, since one of: the aerosol-generating system being reset, the aerosol-generating system being switched on, or the heating element cooling down to an ambient temperature after at least one puff. The method may comprise controlling the supply of power to the heating element in either the first mode or the second mode dependent on a cumulative energy supplied to the heating element within a specified time interval prior to the start of the puff. The method may comprise controlling the supply of power to the heating element in either the first mode or the second mode dependent on a cumulative heating time of the heating element within a specified time interval prior to the start of the puff.

The aerosol-generating system may comprise an aerosol generating device. The aerosol generating device may comprise a receptacle configured to receive an aerosol-generating article or a cartridge containing the aerosol-forming substrate. The aerosol-generating article or the cartridge may be coupled to and uncoupled from the aerosol-generating device. The method may comprise controlling the supply of power to the heating element in either the first mode or the second mode dependent on a number of puffs since the aerosol-generating article or the cartridge has been coupled to the aerosol-generating device. The method may comprise controlling the supply of power to the heating element in either the first mode or the second mode dependent on a cumulative puffing time since the aerosol-generating article or the cartridge has been coupled to the aerosol-generating device.

The method may comprise detecting an adverse condition at the heating element, such as when insufficient aerosol-forming liquid is supplied to the heating element. The method may comprise determining a maximum electrical resistance of the heating element during each puff; calculating a rolling average value of maximum electrical resistance of the heating element for n preceding heating cycles, wherein n is an integer greater than 1; comparing the electrical resistance of the heating element with the calculated rolling average value; determining an adverse condition when the electrical resistance is greater than that the rolling average value by more than a resistance threshold value, said resistance threshold value being stored in the computer readable memory. The method may comprise determining a first derivative or a second derivative of the electrical resistance with respect to time; and determining an adverse condition when the first derivative or the second derivative exceeds or is equal to a first or second derivative threshold value, with the first derivative or the second derivative threshold value being stored in the computer readable memory. The method may comprise calculating a resistance threshold value or a first derivative or a second derivative threshold value for each of the power values of the plurality of power values stored in the computer readable memory. Alternatively, the method may comprise storing in the computer readable memory a resistance threshold value or a first derivative or a second derivative threshold value for each of the power values of the plurality of power values stored in the computer readable memory. The method may comprise determining an adverse condition when the resistance threshold value or the first derivative or the second derivative threshold value is exceeded during two consecutive puffs by the user. The method may comprise adjusting the resistance threshold value or the first derivative or the second derivative threshold value after the resistance threshold value or the first derivative or the second derivative threshold value is first exceeded during a puff by the user.

According to a third aspect of the disclosure, there is provided an aerosol-generating system comprising: an air flow passage extending between an air inlet and an air outlet; a heating element for heating an aerosol-forming substrate; a sensor assembly in communication with the air flow passage, the sensor assembly being configured to measure a pressure or a flow rate within the airflow passage; and a controller comprising a computer readable memory. The controller may be configured to: read the pressure or the flow rate measured by the sensor assembly at regular time intervals, detect a start of a puff when a user puffs on the aerosol-generating system, in a first mode, select a power profile from a plurality of power profiles stored in the computer readable memory, the selection dependent on the pressure or the flow rate read by the controller, and supply power to the heating element in accordance with the selected power profile.

The controller may be configured to, in the first mode, select a power profile at regular time intervals during the puff. In the first mode the selection of a power profile may be based on a most recent pressure or flow rate read by the controller. In the first mode the selection of a power profile may be dependent on the time since the start of the puff.

The duration of the regular time intervals may be between 1 millisecond and 1000 milliseconds. Preferably, the duration of the regular time intervals is between 2 milliseconds and 500 milliseconds, more preferably, the duration of the regular time intervals is between 5 milliseconds and 250 milliseconds, more preferably still, the duration of the regular time intervals is between 10 milliseconds and 100 milliseconds, more preferably still, the duration of the regular time intervals is between 20 milliseconds and 60 milliseconds, and more preferably still, the duration of the regular time intervals is substantially equal to 40 milliseconds.

Preferably the computer readable memory stores a look-up table, the look-up table comprising a plurality of power profiles, each power profile corresponding to a pressure range or a flow rate range, and a time range since the start of a puff. The controller may be configured to, in the first mode, use the look-up table to control the supply of power to the heating element. Advantageously, such a look-up table may provide aerosol-generation that adapts to the puffing behaviour of the user, and is curated for the user. The time ranges may be of equal length. The time ranges may be between 0 milliseconds and 2000 milliseconds. Preferably, the lengths of the time ranges may be between 10 milliseconds and 1500 milliseconds. More preferably, the lengths of the time ranges may be between 50 milliseconds and 1200 milliseconds. More preferably still, the lengths of the time ranges may be between 200 milliseconds and 1000 milliseconds. More preferably still, the lengths of the time ranges may be between 600 milliseconds and 800 milliseconds. The time ranges may be of different lengths. This may mean that the time ranges are best suited to typical variations in pressure during a puff. The number of time ranges in the look-up table may be between 2 and 1000. Preferably, the number of time ranges in the look-up table is between 2 and 100, more preferably between 2 and 50, even more preferably between 2 and 20. More preferably still, the number of time ranges in the look-up table is between 2 and 10, more preferably between 4 and 8, and even more preferably between 5 and 7. In aspects of the disclosure in which pressure ranges or flow rates are used in the look-up table, the pressure ranges or the flow rate ranges may be of substantially equal magnitude. Alternatively, the pressure ranges or the flow rate ranges may be of different magnitudes. This may mean that the pressure ranges or the flow rate ranges are better suited to typical variations in pressure during a puff. The number of pressure ranges or the flow rate ranges in the look-up table may be between 2 and 1000, preferably between 2 and 100, more preferably between 2 and 50, more preferably still, between 2 and 20, more preferably still between 2 and 15, more preferably still between 4 and 10, and most preferably between 7 and 9. The power profiles may be flat, such that the power supplied to the heating element for the duration of the power profile is constant. Alternatively, each power profile may vary with time, such that the power supplied to the heating element for the duration of the power profile may vary with time during the regular time interval. The variation of the power profile with time may be an increase or a decrease of power during the regular time interval, or the power may both increase and decrease at least once during the regular time interval. Such increases or decreases may vary smoothly and continuously with time, or may be discontinuous. The plurality of power profiles may comprise a plurality of different power profiles.

The power profile supplied to the heating element in the first mode may be dependent on the difference between a reference pressure or a reference flow rate, and the pressure or the flow rate read by the controller. The controller may detect the start of a puff when the difference between a reference pressure or a reference flow rate and the pressure or the flow rate read by the controller exceeds a first threshold pressure or a first threshold flow rate. The reference pressure or the reference flow rate may be calculated by the controller as a rolling average of an integer number of pressure values or flow rate values read by the controller preceding the detection of the start of the puff. The first threshold pressure or the first threshold flow rate may be pre-determined. The first threshold pressure or the first threshold flow rate may be stored in the computer readable memory. The first threshold pressure or the first threshold flow rate may be calculated as a proportion or as a multiple of the reference pressure or the reference flow rate.

The controller may be configured to control a supply of power to the heating element in a second mode, wherein the supply of power to the heating element in the second mode is independent of at least one of the measured time since the start of a puff and the pressure or the flow rate read by the controller. In the second mode the power supplied to the heating element may be constant for the duration of the puff. The controller may be further configured to control the supply of power to the heating element in either the first mode or the second mode dependent on a number of puffs since one of: the aerosol-generating system being reset, the aerosol-generating system being switched on, or the heating element cooling down to an ambient temperature after at least one puff. The controller may be configured to control the supply of power to the heating element in either the first mode or the second mode dependent on a cumulative puffing time since one of: the aerosol-generating system being reset, the aerosol-generating system being switched on, or the heating element cooling down to an ambient temperature after at least one puff. The controller may be configured to control the supply of power to the heating element in either the first mode or the second mode dependent on a cumulative energy supplied to the heating element since one of: the aerosol-generating system being reset, the aerosol-generating system being switched on, or the heating element cooling down to an ambient temperature after at least one puff. The controller may be configured to control the supply of power to the heating element in either the first mode or the second mode dependent on a combination of at least two of: a cumulative energy supplied to the heating element, a cumulative puffing time and a number of puffs, since one of: the aerosol-generating system being reset, the aerosol-generating system being switched on, or the heating element cooling down to an ambient temperature after at least one puff. The controller may be configured to control the supply of power to the heating element in either the first mode or the second mode dependent on a cumulative energy supplied to the heating element within a specified time interval prior to the start of the puff. The controller may be configured to control the supply of power to the heating element in either the first mode or the second mode dependent on a cumulative heating time of the heating element within a specified time interval prior to the start of the puff.

Preferably, the aerosol-generating system comprises an aerosol generating device. The aerosol generating device may comprise a receptacle configured to receive an aerosol-generating article or a cartridge containing the aerosol-forming substrate. The aerosol generating article or the cartridge may be coupled to and uncoupled from the aerosol-generating device.

The controller may be configured to control the supply of power to the heating element in either the first mode or the second mode dependent on a number of puffs since the aerosol-generating article or the cartridge has been coupled to the aerosol-generating device. The controller may be configured to control the supply of power to the heating element in either the first mode or the second mode dependent on a cumulative puffing time since the aerosol-generating article or the cartridge has been coupled to the aerosol-generating device.

The controller may be configured to detect an adverse condition at the heating element, such as when insufficient aerosol-forming liquid is supplied to the heating element. The controller may be configured to determine a maximum electrical resistance of the heating element during each puff; calculate a rolling average value of maximum electrical resistance of the heating element for n preceding heating cycles, wherein n is an integer greater than 1; compare the electrical resistance of the heating element with the calculated rolling average value; determine an adverse condition when the electrical resistance is greater than that the rolling average value by more than a resistance threshold value, said resistance threshold value being stored in the computer readable memory. The controller may be configured to determine a first derivative or a second derivative of the electrical resistance with respect to time; and determine an adverse condition when the first derivative or the second derivative exceeds or is equal to a first or second derivative threshold value, with the first derivative or the second derivative threshold value being stored in the computer readable memory. For either configuration, the resistance threshold value or the first derivative or the second derivative threshold value may be dependent on whether the supply of power to the heating element is controlled in the first mode or the second mode. Preferably, the resistance threshold value or the first derivative or the second derivative threshold value is dependent on the power supplied to the heating element. A resistance threshold value or a first derivative or a second derivative threshold value may be calculated for each of the power profiles of the plurality of power profiles stored in the computer readable memory. A resistance threshold value or a first derivative or a second derivative threshold value corresponding to each of the power profiles of the plurality of power profiles stored in the computer readable memory may be stored in the computer readable memory. The controller may determine an adverse condition when the resistance threshold value or the first derivative or the second derivative threshold value is exceeded during two consecutive puffs by the user. In this case, the resistance threshold value or the first derivative or the second derivative threshold value may be adjusted after the resistance threshold value or the first derivative or the second derivative threshold value is first exceeded during a puff by the user.

According to a fourth aspect of the disclosure, there is provided a method of aerosol production in an aerosol-generating system, the system comprising: an air flow passage extending between an air inlet and an air outlet; a heating element for heating an aerosol-forming substrate; and a sensor assembly in communication with the air flow passage, and a controller comprising a computer readable memory. The method may comprise in a first mode: detecting a start of a puff, reading an output from the sensor assembly to determine a pressure or a flow rate in the airflow passage, selecting a power profile from a plurality of power profiles stored in the memory, the selection dependent on the pressure or the flow rate in the airflow passage, and supplying the heating element with power in accordance with the selected power profile.

Preferably, in the first mode the output from the sensor assembly is read at regular time intervals. In the first mode the supply of power to the heating element may be dependent on the difference between a reference pressure or a reference flow rate and the pressure or the flow rate in the airflow passage.

The method may further comprise in the first mode: selecting a power value from a look up table stored in the computer readable memory based on the pressure or the flow rate in the airflow passage and a time since the start of the puff, the look-up table comprising a plurality of power values, each power value corresponding to a pressure range or a flow rate range, and a time range since the start of the puff, and suppling the heating element with power based on the selected power value.

The method may comprise the controller reading an output from the sensor assembly to determine a pressure or a flow rate in the airflow passage. The method may comprise detecting the start of a puff when the difference between the reference pressure or the reference flow rate, and the pressure or the flow rate in the airflow passage exceeds a first threshold pressure or a first threshold flow rate. The reference pressure or the reference flow rate may be calculated by the controller as a rolling average of an integer number of pressure values or flow rate values in the airflow passage preceding the detection of the start of the puff.

The method may comprise controlling the supply of power to the heating element in a second mode. The supply of power to the heating element in the second mode may be independent of at least one of the measured time since the start of a puff and the pressure or the flow rate in the airflow passage. In the second mode the power supplied to the heating element may be constant for the duration of a puff.

The method may comprise controlling the supply of power to the heating element in either the first mode or the second mode dependent on a number of puffs since one of: the aerosol-generating system being reset, the aerosol-generating system being switched on, or the heating element cooling down to an ambient temperature after at least one puff. The method may comprise controlling the supply of power to the heating element in either the first mode or the second mode dependent on a cumulative puffing time since one of: the aerosol-generating system being reset, the aerosol-generating system being switched on, or the heating element cooling down to an ambient temperature after at least one puff. The method may comprise controlling the supply of power to the heating element in either the first mode or the second mode dependent on a cumulative energy supplied to the heating element since one of: the aerosol-generating system being reset, the aerosol-generating system being switched on, or the heating element cooling down to an ambient temperature after at least one puff. The method may comprise controlling the supply of power to the heating element in either the first mode or the second mode dependent on a combination of at least two of: a cumulative energy supplied to the heating element, a cumulative puffing time and a number of puffs, since one of: the aerosol-generating system being reset, the aerosol-generating system being switched on, or the heating element cooling down to an ambient temperature after at least one puff. The method may comprise controlling the supply of power to the heating element in either the first mode or the second mode dependent on a cumulative energy supplied to the heating element within a specified time interval prior to the start of the puff. The method may comprise controlling the supply of power to the heating element in either the first mode or the second mode dependent on a cumulative heating time of the heating element within a specified time interval prior to the start of the puff.

The aerosol-generating system may comprise an aerosol generating device. The aerosol generating device may comprise a receptacle configured to receive an aerosol-generating article or a cartridge containing the aerosol-forming substrate. The aerosol-generating article or the cartridge may be coupled to and uncoupled from the aerosol-generating device. The method may comprise controlling the supply of power to the heating element in either the first mode or the second mode dependent on a number of puffs since the aerosol-generating article or the cartridge has been coupled to the aerosol-generating device. The method may comprise controlling the supply of power to the heating element in either the first mode or the second mode dependent on a cumulative puffing time since the aerosol-generating article or the cartridge has been coupled to the aerosol-generating device.

The method may comprise detecting an adverse condition at the heating element, such as when insufficient aerosol-forming liquid is supplied to the heating element. The method may comprise determining a maximum electrical resistance of the heating element during each puff; calculating a rolling average value of maximum electrical resistance of the heating element for n preceding heating cycles, wherein n is an integer greater than 1; comparing the electrical resistance of the heating element with the calculated rolling average value; determining an adverse condition when the electrical resistance is greater than that the rolling average value by more than a resistance threshold value, said resistance threshold value being stored in the computer readable memory. The method may comprise determining a first derivative or a second derivative of the electrical resistance with respect to time; and determining an adverse condition when the first derivative or the second derivative exceeds or is equal to a first or second derivative threshold value, with the first derivative or the second derivative threshold value being stored in the computer readable memory. The method may comprise calculating a resistance threshold value or a first derivative or a second derivative threshold value for each of the power profiles of the plurality of power profiles stored in the computer readable memory. Alternatively, the method may comprise storing in the computer readable memory a resistance threshold value or a first derivative or a second derivative threshold value for each of the power profiles of the plurality of power profiles stored in the computer readable memory. The method may comprise determining an adverse condition when the resistance threshold value or the first derivative or the second derivative threshold value is exceeded during two consecutive puffs by the user. The method may comprise adjusting the resistance threshold value or the first derivative or the second derivative threshold value after the resistance threshold value or the first derivative or the second derivative threshold value is first exceeded during a puff by the user.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, an “aerosol-generating system” means a system that generates an aerosol from one or more aerosol-forming substrates.

As used herein, the term “aerosol-forming substrate” means a substrate capable of releasing volatile compounds that may form an aerosol. Such volatile compounds may be released by heating the aerosol-forming substrate.

As used herein, the term “puff” is used to describe the action of a user generating aerosol using the aerosol-generating system. The user carries out this action by drawing air through the aerosol-generating system by inhalation.

As used herein, the terms “air inlet’ and ‘air outlet” are used to describe one or more apertures through which air may be drawn into, and out of, respectively, of a component or portion of a component of the aerosol-generating article, aerosol-generating system or aerosol-generating device.

As used herein, the term “aerosol-generating article” refers to an article comprising an aerosol-forming substrate that is capable of releasing volatile compounds that can form an aerosol. An aerosol-generating article may be disposable. Preferably, the aerosol-generating article is a smoking article that generates an aerosol that is directly inhalable into a user's lungs through the user's mouth. More preferably, the aerosol-generating article is a smoking article that generates a nicotine-containing aerosol that is directly inhalable into a user's lungs through the user's mouth. The aerosol-generating article may be a heat-not-burn article.

The aerosol-generating device may, for example, comprise a substrate receiving cavity for receiving a consumable aerosol-generating article comprising an aerosol-forming substrate. The aerosol-forming substrate in an aerosol-generating article may be a solid aerosol-forming substrate. Examples of aerosol-generating articles include sachets filled with solid aerosol-forming substrates, cigarettes and cigarette-like articles that include an aerosol-forming substrate contained within a wrapper such as a cigarette paper, capsules or containers of liquid aerosol-forming substrate or colloidal aerosol-forming substrate. The consumable aerosol-generating article may comprise a replaceable substrate section containing two or more components which form an aerosol when combined. A preferred consumable aerosol-generating article may be in the form of a cigarette or cigarette-like article comprising a solid aerosol-forming substrate contained within a wrapper. Preferably such an article includes a mouth end intended to be inserted into a user's mouth for consumption of the article. Preferably, the mouth end includes a filter to emulate a conventional tailored cigarette. Preferably, the consumable aerosol-generating article is configured to interact with an atomizer, preferably a heater, located in the body of the aerosol-generating device. Thus, a heating means such as a resistance heating element may be located in or around the substrate receiving cavity for receiving the consumable aerosol-generating article. The substrate receiving cavity may be located at a proximal end of the device. For example, an opening to the substrate receiving cavity may be located at the proximal end of the device.

Preferably, the aerosol-forming substrate comprises nicotine. More preferably, the aerosol-forming substrate comprises tobacco. Alternatively or in addition, the aerosol-forming substrate may comprise a non-tobacco containing aerosol-forming material.

If the aerosol-forming substrate is a solid aerosol-forming substrate, the solid aerosol-forming substrate may comprise, for example, one or more of: powder, granules, pellets, shreds, strands, strips or sheets containing one or more of: herb leaf, tobacco leaf, tobacco ribs, expanded tobacco and homogenised tobacco.

Optionally, the solid aerosol-forming substrate may contain tobacco or non-tobacco volatile flavour compounds, which are released upon heating of the solid aerosol-forming substrate. The solid aerosol-forming substrate may also contain one or more capsules that, for example, include additional tobacco volatile flavour compounds or non-tobacco volatile flavour compounds and such capsules may melt during heating of the solid aerosol-forming substrate.

Optionally, the solid aerosol-forming substrate may be provided on or embedded in a thermally stable carrier. The carrier may take the form of powder, granules, pellets, shreds, strands, strips or sheets. The solid aerosol-forming substrate may be deposited on the surface of the carrier in the form of, for example, a sheet, foam, gel or slurry. The solid aerosol-forming substrate may be deposited on the entire surface of the carrier, or alternatively, may be deposited in a pattern in order to provide a non-uniform flavour delivery during use.

In a preferred embodiment, the aerosol-forming substrate comprises homogenised tobacco material. As used herein, the term “homogenised tobacco material” refers to a material formed by agglomerating particulate tobacco.

Preferably, the aerosol-forming substrate comprises a gathered sheet of homogenised tobacco material. As used herein, the term “sheet” refers to a laminar element having a width and length substantially greater than the thickness thereof. As used herein, the term “gathered” is used to describe a sheet that is convoluted, folded, or otherwise compressed or constricted substantially transversely to the longitudinal axis of the aerosol-generating article.

As used herein, the term “cartridge” also refers to an article comprising an aerosol-forming substrate that is capable of releasing volatile compounds that can form an aerosol. A cartridge also may be disposable.

A cartridge may contain a liquid. The liquid may comprise volatile compounds that may form an aerosol. The liquid may form an aerosol upon heating of the liquid. The aerosol-forming substrate may be a liquid. The aerosol-forming substrate may be a liquid at room temperature. The aerosol-forming substrate may be in another condensed form, such as a solid at room temperature, or may be in another condensed form, such as a gel, at room temperature. Volatile compounds may be released by heating the aerosol-forming substrate. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours. The liquid aerosol-forming substrate may comprise nicotine and at least one aerosol former. The aerosol former may be glycerine or propylene glycol. The aerosol former may comprise both glycerine and propylene glycol. The liquid aerosol-forming substrate may have a nicotine concentration of between about 0.5% and about 10%, for example about 2%.

The heating element may be configured to be resistively heated by the application of an electrical current through the heating element. The heating element may be configured to be inductively heated by currents induced in the heating element by a varying magnetic field. The heating element may be configured to be inductively heated by hysteresis effects.

The heating element may take a form suitable for heating the aerosol-forming substrate. In some embodiments the heating element is fluid permeable. The heating element may comprise a plurality of electrically conductive filaments. The aerosol-generating element may comprise fluid permeable mesh. The heating element may comprise a plurality of interstices or apertures extending from the second side to the first side and through which fluid may pass. The heating element may be an array of filaments, for example arranged parallel to each other. Preferably, the filaments may form a mesh. Alternatively, the electrically conductive heating element consists of an array of filaments or a fabric of filaments. The electrically conductive filaments may define interstices between the filaments and the interstices may have a width of between 10 micrometres and 100 micrometres. Preferably, the filaments give rise to capillary action in the interstices, so that in use, liquid to be vaporized is drawn into the interstices, increasing the contact area between the heating element and the liquid aerosol-forming substrate.

The electrically conductive filaments may have a diameter of between 8 micrometres and 100 micrometres, preferably between 10 micrometres and 50 micrometres, more preferably between 12 micrometres and 25 micrometres, and most preferably approximately 16 micrometres. The filaments may have a round cross section or may have a flattened cross-section.

The aerosol-generating element may be configured to be resistively heated. In other words, the aerosol-generating element may be configured to generate heat when an electrical current is passed though the heating element. The heating element, or portions thereof, may comprise or be formed from any material with suitable electrical and mechanical properties, for example a suitable, electrically resistive material. Suitable materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics. Examples of suitable doped ceramics include doped silicon carbides. Examples of suitable metals include titanium, zirconium, tantalum and metals from the platinum group. The electrical resistance of the mesh, array or fabric of electrically conductive filaments of the heater element is preferably between 0.3 and 4 Ohms. More preferably, the electrical resistance of the mesh, array or fabric of electrically conductive filaments is between 0.5 and 3 Ohms, and more preferably about 1 Ohm. Preferably, the electrical resistance is equal or greater than 0.5 Ohms. More preferably, the electrical resistance of the mesh, array or fabric of electrically conductive filaments is between 0.6 Ohms and 0.8 Ohms, and most preferably about 0.68 Ohms. Alternatively, the heating element may comprise a heating plate in which an array of apertures is formed. The apertures may be formed by etching or machining, for example. The plate may be formed from any material with suitable electrical properties, such as the materials described above in relation to filaments of a heating element.

The heating element may be an internal heater designed to be inserted into a consumable aerosol-generating article, for example a resistive heating element or a susceptor in the form of a pin or blade that can be inserted into an aerosol-forming substrate located within a consumable aerosol-generating article. The heating element may be an external heater designed to heat an external surface of a consumable aerosol-generating article, for example a resistive heating element or a susceptor located at the periphery of, or surrounding, a substrate receiving cavity for receiving the consumable aerosol-generating article.

The aerosol-generating element may comprise a susceptor element. In other words, the aerosol-generating element may be configured to operate by inductive heating. In operation, the susceptor may be heated by eddy currents induced in the susceptor. Hysteresis losses may also contribute to the inductive heating.

The aerosol-generating device may comprise a power supply, for example a battery. The power supply may be a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel metal hydride battery or a Nickel cadmium battery. The power supply may be another form of charge storage device such as a capacitor.

The power supply may be connected to the heating element. The aerosol-generating device may comprise a controller. The controller may be connected to the power source. The controller may be connected to the heating element. The controller may control the supply of power from the power source to the heating element. The controller may control a temperature of the heating element. The controller may comprise a microcontroller. The microcontroller may be a programmable microcontroller.

The aerosol-generating system may be a handheld aerosol-generating system configured to allow a user to suck on a mouthpiece to draw an aerosol through the first air outlet. The aerosol-generating system may have a size comparable to a conventional cigar or cigarette. The aerosol-generating system may have a total length between about 25 mm and about 150 mm. The aerosol-generating system may have an external diameter between about 5 mm and about 30 mm.

The invention is defined in the claims. However, below there is provided a non-exhaustive list of non-limiting examples. Any one or more of the features of these examples may be combined with any one or more features of another example, embodiment, or aspect described herein.
Example Ex1: An aerosol-generating system comprising: an air inlet and an air outlet; an air flow passage extending between the air inlet and the air outlet; a heating element for heating an aerosol-forming substrate; a sensor assembly in communication with the air flow passage, the sensor assembly being configured to measure a pressure or a flow rate within the airflow passage; and a controller configured to detect a start of a puff, read the pressure or the flow rate measured by the sensor assembly, and control a supply of power to the heating element in a first mode in response to the start of the puff, wherein the controller controls the supply of power to the heating element in the first mode dependent on both the time since the start of the puff and the pressure or the flow rate read by the controller following the start of the puff.
Example Ex2: An aerosol-generating system according to example Ex1, wherein the controller is further configured in the first mode to read the pressure or the flow rate from the sensor assembly at regular time intervals.
Example Ex3: An aerosol-generating system according to example Ex1 or Ex2, wherein the controller comprises a computer readable memory storing a look-up table, the look-up table comprising a plurality of power values, each power value corresponding to a pressure range or a flow rate range, and a time range since the start of a puff, and the controller is further configured in the first mode to use the look-up table to control the supply of power to the heating element.
Example Ex4: An aerosol-generating system according to any preceding example, wherein the supply of power to the heating element in the first mode is dependent on the difference between a reference pressure or a reference flow rate, and the pressure or the flow rate read by the controller.
Example Ex5: An aerosol-generating system according to example Ex4, wherein the controller detects the start of a puff when the difference between the reference pressure or the reference flow rate, and the pressure or the flow rate read by the controller exceeds a first threshold pressure or a first threshold flow rate.
Example Ex6: An aerosol-generating system according to example Ex4 or Ex5, wherein the reference pressure or the reference flow rate is calculated by the controller as a rolling average of an integer number of pressure values or flow rate values read by the controller preceding the detection of the start of the puff.
Example Ex7: An aerosol-generating system according to example Ex5, wherein the first threshold pressure or the first threshold flow rate is calculated as a proportion or a multiple of the reference pressure or the reference flow rate.
Example Ex8: An aerosol-generating system according to example Ex5, wherein the first threshold pressure or the first threshold flow rate is pre-determined.
Example Ex9: An aerosol-generating system according to example Ex8, wherein the first threshold pressure or the first threshold flow rate is stored in the computer readable memory.
Example Ex10: An aerosol-generating system according to any one of examples Ex3 to Ex9, wherein the look-up table comprises between 2 and 10 time ranges.
Example Ex11: An aerosol-generating system according to any of examples Ex3 to Ex10, wherein the lengths of the time ranges are between 200 milliseconds and 1000 milliseconds.
Example Ex12: An aerosol-generating system according to any of examples Ex3 to Ex11, wherein the look-up table comprises between 2 and 15 pressure ranges or flow rate ranges.
Example Ex13. An aerosol-generating system according to any of examples Ex2 to Ex12, wherein the durations of the regular time intervals are between 10 and 100 milliseconds.
Example Ex14: An aerosol-generating system according to any preceding example, wherein the controller is further configured to control a supply of power to the heating element in a second mode, wherein the supply of power to the heating element in the second mode is independent of at least one of the measured time since the start of a puff and the pressure or the flow rate read by the controller.
Example Ex15: An aerosol-generating system according to example Ex14, wherein in the second mode the power supplied to the heating element is constant for the duration of a puff.
Example Ex16: An aerosol-generating system according to example Ex14 or Ex15 wherein the controller is further configured to control the supply of power to the heating element in either the first mode or the second mode dependent on a number of puffs since one of: the aerosol-generating system being reset, the aerosol-generating system being switched on, or the heating element cooling down to an ambient temperature after at least one puff.
Example Ex17: An aerosol-generating system according to example Ex14 or Ex15 wherein the controller is further configured to control the supply of power to the heating element in either the first mode or the second mode dependent on a cumulative puffing time since one of: the aerosol-generating system being reset, the aerosol-generating system being switched on, or the heating element cooling down to an ambient temperature after at least one puff.
Example Ex18: An aerosol-generating system according to example Ex14 or Ex15 wherein the controller is further configured to control the supply of power to the heating element in either the first mode or the second mode dependent on a cumulative energy supplied to the heating element since one of: the aerosol-generating system being reset, the aerosol-generating system being switched on, or the heating element cooling down to an ambient temperature after at least one puff.
Example Ex19: An aerosol-generating system according to example Ex14 or Ex15 wherein the controller is further configured to control the supply of power to the heating element in either the first mode or the second mode dependent on a combination of at least two of: a cumulative energy supplied to the heating element, a cumulative puffing time and a number of puffs, since one of: the aerosol-generating system being reset, the aerosol-generating system being switched on, or the heating element cooling down to an ambient temperature after at least one puff.
Example Ex20: An aerosol-generating system according to example Ex14 or Ex15 wherein the controller is further configured to control the supply of power to the heating element in either the first mode or the second mode dependent on a cumulative energy supplied to the heating element within a specified time interval prior to the start of the puff.
Example Ex21: An aerosol-generating system according to example Ex14 or Ex15 wherein the controller is further configured to control the supply of power to the heating element in either the first mode or the second mode dependent on a cumulative heating time of the heating element within a specified time interval prior to the start of the puff.
Example Ex22: An aerosol-generating system according to example Ex14 or Ex15, wherein the aerosol-generating system comprises an aerosol generating device, the aerosol generating device comprising a receptacle configured to receive an aerosol-generating article or a cartridge containing the aerosol-forming substrate, and the aerosol generating article or the cartridge can be coupled to and uncoupled from the aerosol-generating device.
Example Ex23: An aerosol-generating system according to example Ex22, wherein the controller is further configured to control the supply of power to the heating element in either the first mode or the second mode dependent on a number of puffs since the aerosol-generating article or the cartridge has been coupled to the aerosol-generating device.
Example Ex24: An aerosol-generating system according to example Ex22, wherein the controller is further configured to control the supply of power to the heating element in either the first mode or the second mode dependent on a cumulative puffing time since the aerosol-generating article or the cartridge has been coupled to the aerosol-generating device.
Example Ex25: An aerosol-generating system according to example Ex22, wherein the controller is further configured to control the supply of power to the heating element in either the first mode or the second mode dependent on a cumulative energy supplied to the heating element since the aerosol-generating article or the cartridge has been coupled to the aerosol-generating device.
Example Ex26: An aerosol-generating system according to any preceding example, wherein the supply of power to the heating element is controlled by controlling at least one of a voltage or a current supplied to the heating element.
Example Ex27: An aerosol-generating system according to example Ex26, wherein the voltage or the current is controlled by pulse width modulation.
Example Ex28: An aerosol-generating system according to any preceding example, wherein the heating element is a resistive heating element.
Example Ex29: An aerosol-generating system according to example Ex28, wherein the resistive heating element is a mesh, array or fabric of electrically conductive filaments.
Example Ex30: An aerosol-generating system according to example Ex29, wherein the aerosol-generating article or cartridge containing the aerosol-forming substrate supplies an aerosol-forming liquid to the resistive heating element, and the controller is further configured to detect when insufficient aerosol-forming liquid is supplied to the resistive heating element.
Example Ex31: An aerosol-generating system according to example Ex30, wherein the controller is configured to detect when insufficient aerosol-forming liquid is supplied to the resistive heating element when the electrical resistance, a first derivative of the electrical resistance with respect to time, or a second derivative of the electrical resistance with respect to time is greater than that the rolling average value by more than a resistance threshold value or a first derivative threshold value or second derivative threshold value, the resistance threshold value or first derivative threshold value or second derivative threshold value being stored in the computer readable memory.
Example Ex32: An aerosol-generating system according to example Ex31, wherein the resistance threshold value or first derivative threshold value or second derivative threshold value is dependent on whether the supply of power to the heating element is controlled in the first mode or the second mode.
Example Ex33: An aerosol-generating system according to example Ex31 or Ex32, wherein the resistance threshold value or first derivative threshold value or second derivative threshold value is dependent on the power supplied to the heating element.
Example Ex34: A method of aerosol production in an aerosol generating system, the system comprising: an air flow passage extending between an air inlet and an air outlet; a heating element for heating an aerosol-forming substrate; a sensor assembly in communication with the air flow passage; and a controller comprising a computer readable memory, the method comprising in a first mode: detecting a start of a puff, reading an output from the sensor assembly to determine a pressure or a flow rate in the airflow passage, and supplying the heating element with a supply of power dependent on both the time since the start of the puff and the pressure or the flow rate in the airflow passage.
Example Ex35: A method of aerosol production in an aerosol generating system according to example Ex34, wherein in the first mode the output from the sensor assembly is read at regular time intervals.
Example Ex36: A method of aerosol production in an aerosol generating system according to example Ex35, wherein in the first mode the supply of power to the heating element is dependent on the difference between a reference pressure or a reference flow rate and the pressure or the flow rate in the airflow passage.
Example Ex37: A method of aerosol production in an aerosol generating system according to example Ex35 or Ex36, the method further comprising in the first mode: selecting a power value from a look up table stored in the computer readable memory based on the pressure or the flow rate in the airflow passage and a time since the start of the puff, the look-up table comprising a plurality of power values, each power value corresponding to a pressure range or a flow rate range, and a time range since the start of the puff, and suppling the heating element with power based on the selected power value.
Example Ex38: A method of aerosol production in an aerosol generating system according to any of example Ex34 to Ex37, the method further comprising detecting the start of a puff when the difference between the reference pressure or the reference flow rate, and the pressure or the flow rate in the airflow passage exceeds a first threshold pressure or a first threshold flow rate.
Example Ex39: A method of aerosol production in an aerosol generating system according to any of example Ex34 to Ex38, the method further comprising controlling the power supplied to the heating element in a second mode, wherein the supply of power to the heating element in the second mode is independent of at least one of the measured time since the start of a puff and the pressure or the flow rate in the airflow passage.
Example Ex40: A method of aerosol production in an aerosol generating system according to example Ex39, wherein in the second mode the supply of power to the heating element is constant for the duration of a puff.
Example Ex41: A method of aerosol production in an aerosol generating system according to example Ex39 or Ex40, the method further comprising controlling the supply of power to the heating element in either the first mode or the second mode dependent on a number of puffs since one of: the aerosol-generating system being reset, the aerosol-generating system being switched on, or the heating element cooling down to an ambient temperature after at least one puff.
Example Ex42: A method of aerosol production in an aerosol generating system according to example Ex39 or Ex40, the method further comprising controlling the supply of power to the heating element in either the first mode or the second mode dependent on a cumulative puffing time since one of: the aerosol-generating system being reset, the aerosol-generating system being switched on, or the heating element cooling down to an ambient temperature after at least one puff.
Example Ex43: A method of aerosol production in an aerosol generating system according to example Ex39 or Ex40, the method further comprising controlling the supply of power to the heating element in either the first mode or the second mode dependent on a cumulative energy supplied to the heating element since one of: the aerosol-generating system being reset, the aerosol-generating system being switched on, or the heating element cooling down to an ambient temperature after at least one puff.
Example Ex44: A method of aerosol production in an aerosol generating system according to example Ex39 or Ex40, the method further comprising controlling the supply of power to the heating element in either the first mode or the second mode dependent on a combination of at least two of: a cumulative energy supplied to the heating element, a cumulative puffing time and a number of puffs, since one of: the aerosol-generating system being reset, the aerosol-generating system being switched on, or the heating element cooling down to an ambient temperature after at least one puff.
Example Ex45: A method of aerosol production in an aerosol generating system according to example Ex39 or Ex40, the method further comprising controlling the supply of power to the heating element in either the first mode or the second mode dependent on a cumulative energy supplied to the heating element within a specified time interval prior to the start of the puff.
Example Ex46: A method of aerosol production in an aerosol generating system according to example Ex39 or Ex40, the method further comprising controlling the supply of power to the heating element in either the first mode or the second mode dependent on a cumulative heating time of the heating element within a specified time interval prior to the start of the puff.
Example Ex47: A method of aerosol production in an aerosol generating system according to example Ex39 or Ex40, wherein the aerosol-generating system comprises an aerosol generating device, the aerosol generating device comprising a receptacle configured to receive an aerosol-generating article or a cartridge containing the aerosol-forming substrate, and the aerosol generating article or the cartridge can be coupled to and uncoupled from the aerosol-generating device.
Example Ex48: A method of aerosol production in an aerosol generating system according to example Ex47, the method further comprising controlling the supply of power to the heating element in either the first mode or the second mode dependent on a number of puffs since the aerosol-generating article or the cartridge has been coupled to the aerosol-generating device.
Example Ex49: A method of aerosol production in an aerosol generating system according to example Ex47, the method further comprising controlling the supply of power to the heating element in either the first mode or the second mode dependent on a cumulative puffing time since the aerosol-generating article or the cartridge has been coupled to the aerosol-generating device.
Example Ex50: A method of aerosol production in an aerosol generating system according to example Ex47, the method further comprising controlling the supply of power to the heating element in either the first mode or the second mode dependent on a cumulative energy supplied to the heating element since the aerosol-generating article or the cartridge has been coupled to the aerosol-generating device.
Example Ex51: An aerosol-generating system comprising: an air flow passage extending between an air inlet and an air outlet; a heating element for heating an aerosol-forming substrate; a sensor assembly in communication with the air flow passage, the sensor assembly being configured to measure a pressure or a flow rate within the airflow passage; and a controller comprising a computer readable memory, the controller configured to: read the pressure or the flow rate measured by the sensor assembly at regular time intervals, detect a start of a puff when a user puffs on the aerosol-generating system, in a first mode, select a power profile from a plurality of power profiles stored in the computer readable memory, the selection dependent on the pressure or the flow rate read by the controller, and supply power to the heating element in accordance with the selected power profile.
Example Ex52: An aerosol-generating system according to example Ex51, wherein the controller is configured to in the first mode select a power profile at regular time intervals during the puff.
Example Ex53: An aerosol-generating system according to example Ex52, wherein in the first mode the selection of a power profile is based on a most recent pressure or flow rate read by the controller.
Example Ex54: An aerosol-generating system according to example Ex51, Ex52 or Ex53, wherein in the first mode the selection of a power profile is dependent on the time since the start of the puff.
Example Ex55: An aerosol-generating system according to example Ex54, wherein the computer readable memory stores a look-up table, the look-up table comprising a plurality of power profiles, each power profile corresponding to a pressure range or a flow rate range, and a time range since the start of a puff, and the controller is further configured in the first mode to use the look-up table to control the supply of power to the heating element.
Example Ex56: An aerosol-generating system according to any of examples Ex51 to Ex55, wherein the power profile supplied to the heating element in the first mode is dependent on the difference between a reference pressure or a reference flow rate, and the pressure or the flow rate read by the controller.
Example Ex57: An aerosol-generating system according to example Ex56, wherein the controller detects the start of a puff when the difference between a reference pressure or a reference flow rate and the pressure or the flow rate read by the controller exceeds a first threshold pressure or a first threshold flow rate.
Example Ex58: An aerosol-generating system according to example Ex57, wherein the reference pressure or the reference flow rate is calculated by the controller as a rolling average of an integer number of pressure values or flow rate values read by the controller preceding the detection of the start of the puff.
Example Ex59: An aerosol-generating system according to of examples Ex51 to Ex58, wherein the controller is further configured to control a supply of power to the heating element in a second mode, wherein the supply of power to the heating element in the second mode is independent of at least one of the measured time since the start of a puff and the pressure or the flow rate read by the controller.
Example Ex60: An aerosol-generating system according to example Ex59, wherein in the second mode the power supplied to the heating element is constant for the duration of the puff.
Example Ex61: An aerosol-generating system according to example Ex59 or Ex60, wherein the controller is further configured to control the supply of power to the heating element in either the first mode or the second mode dependent on a number of puffs since one of: the aerosol-generating system being reset, the aerosol-generating system being switched on, or the heating element cooling down to an ambient temperature after at least one puff.
Example Ex62: An aerosol-generating system according to example Ex59 or Ex60, wherein the controller is further configured to control the supply of power to the heating element in either the first mode or the second mode dependent on a cumulative puffing time since one of: the aerosol-generating system being reset, the aerosol-generating system being switched on, or the heating element cooling down to an ambient temperature after at least one puff.
Example Ex63: An aerosol-generating system according to example Ex59 or Ex60, wherein the controller is further configured to control the supply of power to the heating element in either the first mode or the second mode dependent on a cumulative energy supplied to the heating element since one of: the aerosol-generating system being reset, the aerosol-generating system being switched on, or the heating element cooling down to an ambient temperature after at least one puff.
Example Ex64: An aerosol-generating system according to example Ex59 or Ex60, wherein the controller is further configured to control the supply of power to the heating element in either the first mode or the second mode dependent on a combination of at least two of: a cumulative energy supplied to the heating element, a cumulative puffing time and a number of puffs, since one of: the aerosol-generating system being reset, the aerosol-generating system being switched on, or the heating element cooling down to an ambient temperature after at least one puff.
Example Ex65: An aerosol-generating system according to example Ex59 or Ex60, wherein the controller is further configured to control the supply of power to the heating element in either the first mode or the second mode dependent on a cumulative energy supplied to the heating element within a specified time interval prior to the start of the puff.
Example Ex66: An aerosol-generating system according to example Ex59 or Ex60, wherein the controller is further configured to control the supply of power to the heating element in either the first mode or the second mode dependent on a cumulative heating time of the heating element within a specified time interval prior to the start of the puff.
Example Ex67: An aerosol-generating system according to example Ex59 or Ex60, wherein the aerosol-generating system comprises an aerosol generating device, the aerosol generating device comprising a receptacle configured to receive an aerosol-generating article or a cartridge containing the aerosol-forming substrate, and the aerosol generating article or the cartridge can be coupled to and uncoupled from the aerosol-generating device.
Example Ex68: An aerosol-generating system according to example Ex67, wherein the controller is further configured to control the supply of power to the heating element in either the first mode or the second mode dependent on a number of puffs since the aerosol-generating article or the cartridge has been coupled to the aerosol-generating device.
Example Ex69: An aerosol-generating system according to example Ex67, wherein the controller is further configured to control the supply of power to the heating element in either the first mode or the second mode dependent on a cumulative puffing time since the aerosol-generating article or the cartridge has been coupled to the aerosol-generating device.
Example Ex70: An aerosol-generating system according to example Ex67, wherein the controller is further configured to control the supply of power to the heating element in either the first mode or the second mode dependent on a cumulative energy supplied to the heating element since the aerosol-generating article or the cartridge has been coupled to the aerosol-generating device.
Example Ex71: An aerosol-generating system according to any of examples Ex51 to Ex70, wherein the power profiles are flat, such that the power to the heating element for the duration of the power profile is constant.
Example Ex72: An aerosol-generating system according to any of examples Ex51 to Ex70, wherein each power profile varies with time, such that the power supplied to the heating element for the duration of the power profile varies with time during the regular time interval.
Example Ex73: An aerosol-generating system according to any of examples Ex51 to Ex72, wherein the plurality of power profiles comprises a plurality of different power profiles.
Example Ex74: A method of aerosol production in an aerosol-generating system, the system comprising: an air flow passage extending between an air inlet and an air outlet; a heating element for heating an aerosol-forming substrate; and a sensor assembly in communication with the air flow passage, a controller comprising a computer readable memory, the method comprising in a first mode: detecting a start of a puff, reading an output from the sensor assembly to determine a pressure or a flow rate in the airflow passage, selecting a power profile from a plurality of power profiles stored in the computer readable memory, the selection dependent on the pressure or the flow rate in the airflow passage, and supplying the heating element with power in accordance with the selected power profile.
Example Ex75: A method of aerosol production in an aerosol-generating system according to example Ex74, wherein in the first mode the selection of the power profile is dependent on a time since the start of the puff.
Example Ex76: A method of aerosol production in an aerosol-generating system according to example Ex75, wherein in the first mode the output from the sensor assembly is read at regular time intervals.
Example Ex77: A method of aerosol production in an aerosol generating system according to example Ex76, wherein in the first mode the selection of the power profile is dependent on the difference between a reference pressure or a reference flow rate and the pressure or the flow rate in the airflow passage.
Example Ex78: A method of aerosol production in an aerosol generating system according to any of example Ex74 to Ex77, the method further comprising detecting the start of a puff when the difference between the reference pressure or the reference flow rate, and the pressure or the flow rate in the airflow passage exceeds a first threshold pressure or a first threshold flow rate.
Example Ex79: A method of aerosol production in an aerosol generating system according to any of example Ex74 to Ex78, the method further comprising controlling the power supplied to the heating element in a second mode, wherein the supply of power to the heating element in the second mode is independent of at least one of the measured time since the start of a puff and the pressure or the flow rate in the airflow passage.
Example Ex80: A method of aerosol production in an aerosol generating system according to example Ex79, wherein in the second mode the supply of power to the heating element is constant for the duration of a puff.
Example Ex81: A method of aerosol production in an aerosol generating system according to example Ex79 or Ex80, the method further comprising controlling the supply of power to the heating element in either the first mode or the second mode dependent on a number of puffs since one of: the aerosol-generating system being reset, the aerosol-generating system being switched on, or the heating element cooling down to an ambient temperature after at least one puff.
Example Ex82: A method of aerosol production in an aerosol generating system according to example Ex79 or Ex80, the method further comprising controlling the supply of power to the heating element in either the first mode or the second mode dependent on a cumulative puffing time since one of: the aerosol-generating system being reset, the aerosol-generating system being switched on, or the heating element cooling down to an ambient temperature after at least one puff.
Example Ex83: A method of aerosol production in an aerosol generating system according to example Ex79 or Ex80, the method further comprising controlling the supply of power to the heating element in either the first mode or the second mode dependent on a cumulative energy supplied to the heating element since one of: the aerosol-generating system being reset, the aerosol-generating system being switched on, or the heating element cooling down to an ambient temperature after at least one puff.
Example Ex84: A method of aerosol production in an aerosol generating system according to example Ex79 or Ex80, the method further comprising controlling the supply of power to the heating element in either the first mode or the second mode dependent on a combination of at least two of: a cumulative energy supplied to the heating element, a cumulative puffing time and a number of puffs, since one of: the aerosol-generating system being reset, the aerosol-generating system being switched on, or the heating element cooling down to an ambient temperature after at least one puff.
Example Ex85: A method of aerosol production in an aerosol generating system according to example Ex79 or Ex80, the method further comprising controlling the supply of power to the heating element in either the first mode or the second mode dependent on a cumulative energy supplied to the heating element within a specified time interval prior to the start of the puff.
Example Ex86: A method of aerosol production in an aerosol generating system according to example Ex79 or Ex80, the method further comprising controlling the supply of power to the heating element in either the first mode or the second mode dependent on a cumulative heating time of the heating element within a specified time interval prior to the start of the puff.
Example Ex87: A method of aerosol production in an aerosol generating system according to example Ex79 or Ex80, wherein the aerosol-generating system comprises an aerosol generating device, the aerosol generating device comprising a receptacle configured to receive an aerosol-generating article or a cartridge containing the aerosol-forming substrate, and the aerosol generating article or the cartridge can be coupled to and uncoupled from the aerosol-generating device.
Example Ex88: A method of aerosol production in an aerosol generating system according to example Ex87, the method further comprising controlling the supply of power to the heating element in either the first mode or the second mode dependent on a number of puffs since the aerosol-generating article or the cartridge has been coupled to the aerosol-generating device.
Example Ex89: A method of aerosol production in an aerosol generating system according to example Ex87, the method further comprising controlling the supply of power to the heating element in either the first mode or the second mode dependent on a cumulative puffing time since the aerosol-generating article or the cartridge has been coupled to the aerosol-generating device.
Example Ex90: A method of aerosol production in an aerosol generating system according to example Ex87, the method further comprising controlling the supply of power to the heating element in either the first mode or the second mode dependent on a cumulative energy supplied to the heating element since the aerosol-generating article or the cartridge has been coupled to the aerosol-generating device.

The invention will be further described, by way of example only, with reference to the accompanying drawings in which:

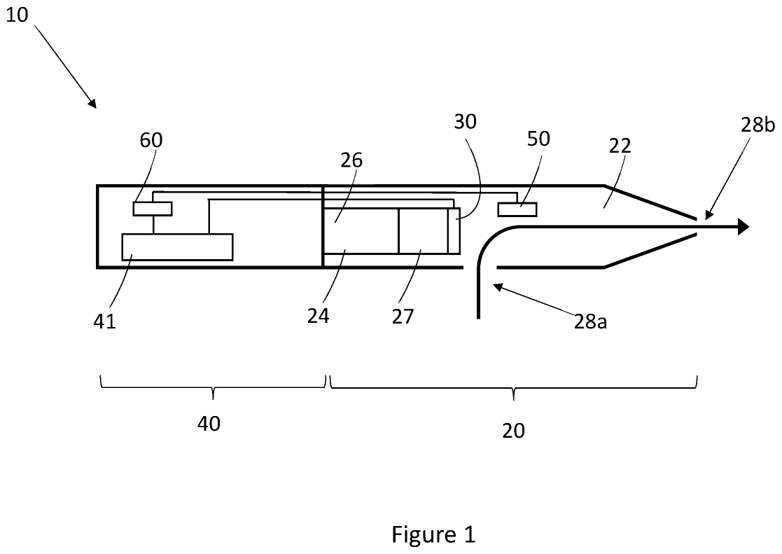

FIG. 1 shows a schematic view of an aerosol-generating system according to the present disclosure.

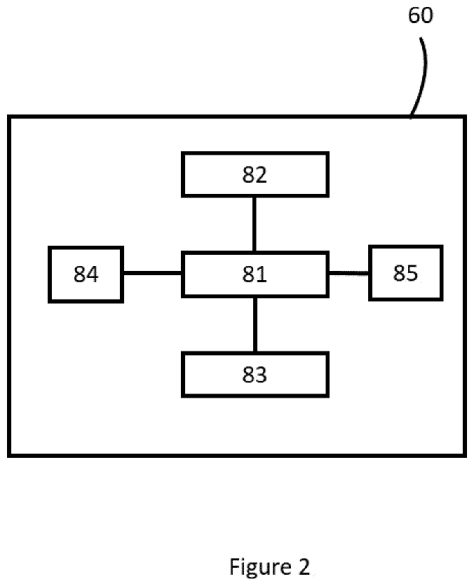

FIG. 2 shows a schematic view of a controller according to the present disclosure.

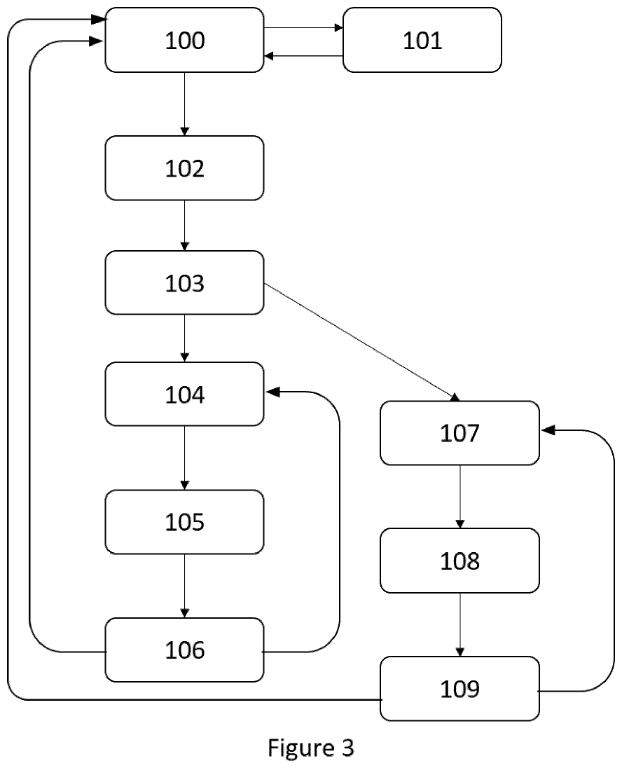

FIG. 3 shows a flow diagram of a method of detecting a puff and supplying power to a heating element either in a first mode or a second mode.

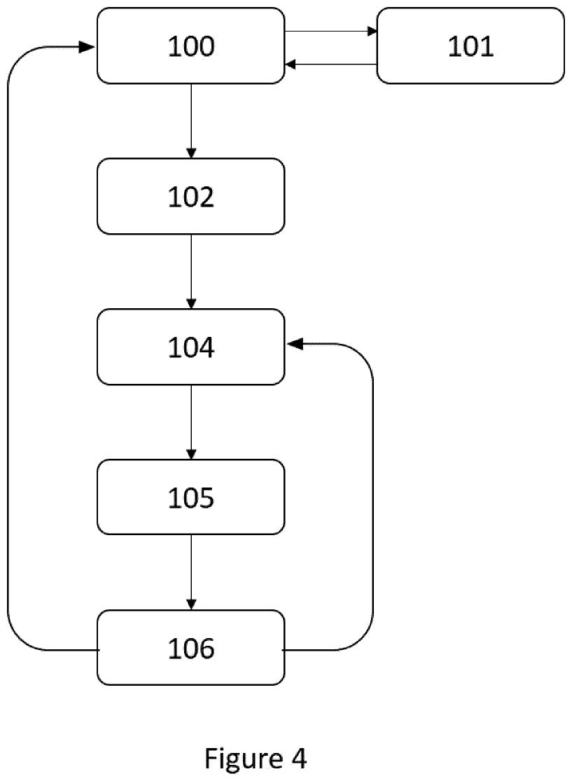

FIG. 4 shows a flow diagram of another method of detecting a puff and supplying power to a heating element either in a first mode or a second mode.

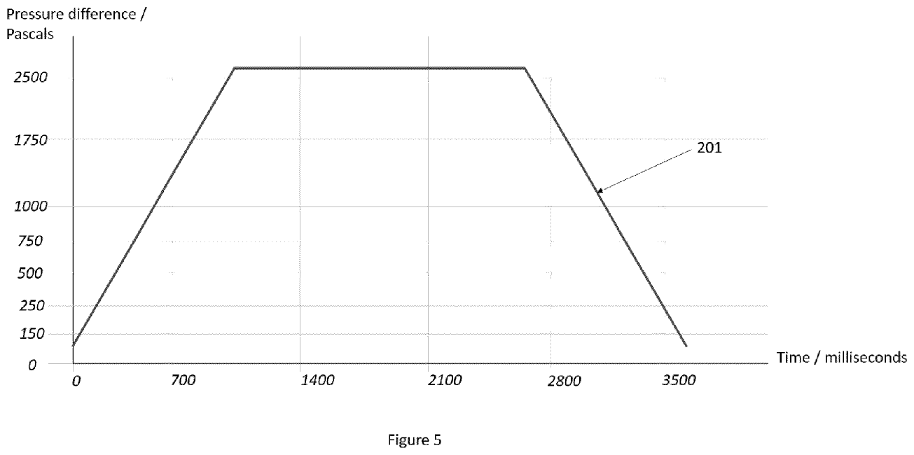

FIG. 5 shows an example representation of a puff profile of pressure difference versus time.

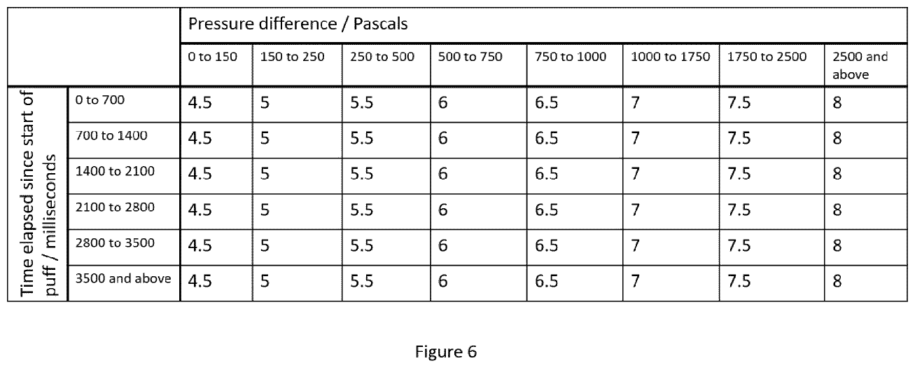

FIG. 6 shows an example look-up table used by a controller according to the present disclosure.

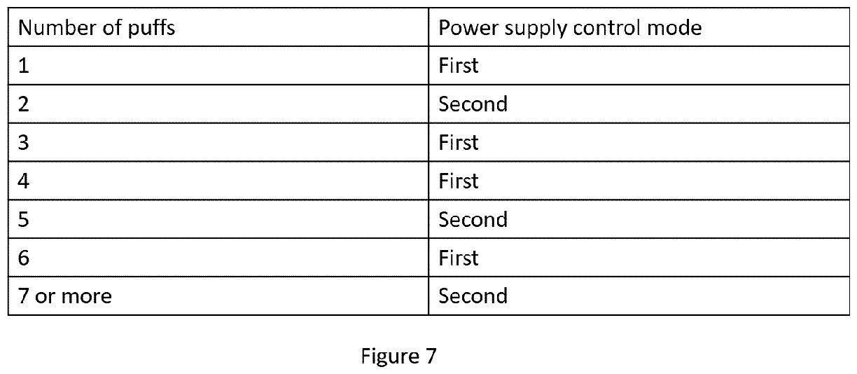

FIG. 7 shows an example table of puff numbers and the associated power supply modes.

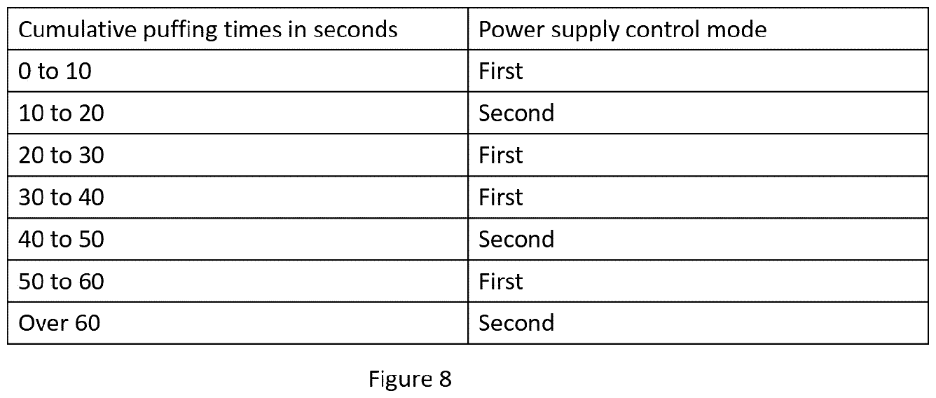

FIG. 8 shows an example table of cumulative puffing time ranges and the associated power supply modes.

FIG. 1 is a schematic view of an aerosol-generating system 10 comprising an aerosol-generating device 40 and an aerosol-generating cartridge 20. The aerosol generating device 40 is configured to receive the aerosol-generating cartridge 20. The aerosol generating cartridge 20 and an aerosol-generating device 40 are coupled together, and can be uncoupled from one another by the user. The device comprises a power supply 41, in the form of a battery, and controller 60 comprising control circuitry coupled to the power supply 41.

The aerosol-generating cartridge 20 comprises a housing 22, which forms a mouthpiece for the system. Within the housing there is a storage container 24 holding liquid aerosol-forming substrate 26. A capillary body 27 is disposed adjacent to an open end of the liquid storage container 24. An electric heater 30 is provided adjacent to an outer surface of the capillary body 27, so that the capillary body 27 can convey the liquid aerosol-forming substrate 26 from the liquid storage container 24 to the electric heater 30. The capillary body 27 and the electric heater 30 together form at least part of a heater assembly 31. The electric heater 30 is also disposed adjacent to an airflow path in the aerosol-generating cartridge 20. The airflow path is indicated by a curved arrow in FIG. 1. The airflow path extends from an air inlet 28a to an air outlet 28b formed at a mouth end opening in the aerosol-generating article housing 22. When the aerosol-generating cartridge 20 is coupled to the aerosol-generating device 40 as shown in FIG. 1, the electric heater 30 is electrically coupled to the power supply 41. The device 40 therefore functions to supply electrical power to the electric heater 30 in the aerosol-generating cartridge 20 in order to vaporise the liquid aerosol-forming substrate. The vaporised aerosol-forming substrate is entrained in an airflow through the system, the airflow resulting from a user puffing on a mouth end of the aerosol-generating cartridge 20. The vaporised aerosol-forming substrate cools in the airflow to form an aerosol before being drawn into a user's mouth.

A sensor assembly 50 comprising a pressure level sensor is disposed in the aerosol-generating cartridge 20 adjacent to the airflow path. It can also be understood that alternatively, sensor assembly 50 may comprise a flow-rate sensor, such that all following references to pressure in this description may be replaced with flow rate. The sensor assembly 50 is coupled to the controller 60 and configured to send measurement data from the pressure level sensor to the controller 60. Although the sensor assembly 50 is shown in FIG. 1 as being disposed within the aerosol-generating article 20, it will be appreciated that the sensor assembly 50 could alternatively be disposed within the aerosol-generating device 40, such that the air flow path passes at least partially through the aerosol-generating cartridge 20. Additionally, it will be appreciated that the electric heater 30 could be disposed within the aerosol-generating device 40.

FIG. 2 is a schematic block diagram of a controller 60 in accordance with the present invention. The controller includes a receiving module 82 configured to receive measurement data from the sensor assembly 50, a determining module 81 configured to determine an amount of power to be supplied to the heating element 30, and a power supplying module 83 configured to initiate the supply of power to the heating element 30. The determining module 81 is coupled to a clock 84 and a computer readable memory 85. A look-up table is stored on computer readable memory 85, and used by the controller in a first mode to determine the power to supply to the heating element. An example look-up table is shown in FIG. 6. Also stored on computer readable memory 85 are mode look-up tables, as shown in FIGS. 7, 8, 9, 10 and 11, and a first threshold pressure, as defined below.

FIG. 3 is a flow diagram showing a method of detecting a puff and supplying power to a heating element in either a first mode or a second mode according to the invention. After the user powers on, resets, or inserts an aerosol-generating article into the device of the aerosol-generating system, at step 100 the controller is configured to read the pressure measured by the sensor assembly at regular time intervals. The controller compares the pressure measured by the sensor assembly to a pressure rolling average based on N previous pressures measured by the sensor assembly, wherein N is an integer selected by the manufacturer of the aerosol-generating system.

The rolling pressure average is referred to as the reference pressure. The reference pressure is stored and updated in, and read by the controller from, the computer readable memory 85.

The difference between the pressure measured by the sensor assembly and the reference pressure is referred to as ΔP. In particular, ΔP is calculated using equation 1 below

$$Δ P = {P}_{ref} - P \qquad ( 1 )$$

where P_{ref} is the reference pressure and P is the pressure measured by the sensor assembly. The pressure at the sensor assembly is reduced when the user takes a puff, so ΔP should be greater than zero when the user is taking a puff.

A pre-determined first threshold pressure is stored in the computer readable memory of the controller. If ΔP is less than or equal to the first threshold pressure, the controller recalculates the reference pressure using the most recent pressure measured by the sensor assembly at step 101.

If ΔP is greater than the first threshold pressure, the controller does not recalculate the reference pressure using the most recent pressure measured by the sensor assembly. The time at which ΔP is greater than the first threshold pressure is registered by the controller as the start of a puff at step 102.

In the described first and second exemplary implementations according to the invention, the method then includes the step 103 of the controller determining whether to control the supply of power to the heating element either in a first mode or a second mode.

In a first exemplary implementation the controller determines whether to control the supply of power to the heating element either in a first mode or a second mode at step 103 depending on the cumulative number of puffs since one of: the aerosol-generating system being reset, the aerosol-generating system being switched on, the heating element cooling down to an ambient temperature after at least one puff, or, in exemplary implementations in which the aerosol-generating system comprises an aerosol generating device, the aerosol generating device comprising a receptacle configured to receive an aerosol-generating article or a cartridge containing the aerosol-forming substrate, the aerosol-generating article or the cartridge being coupled to the aerosol-generating device. The controller determines which mode to control the supply of power to the heating element in by using a mode look-up table. An example mode look-up table is shown in FIG. 7. The mode look-up table is pre-determined by the manufacturer and pre-loaded into the computer readable memory 85.

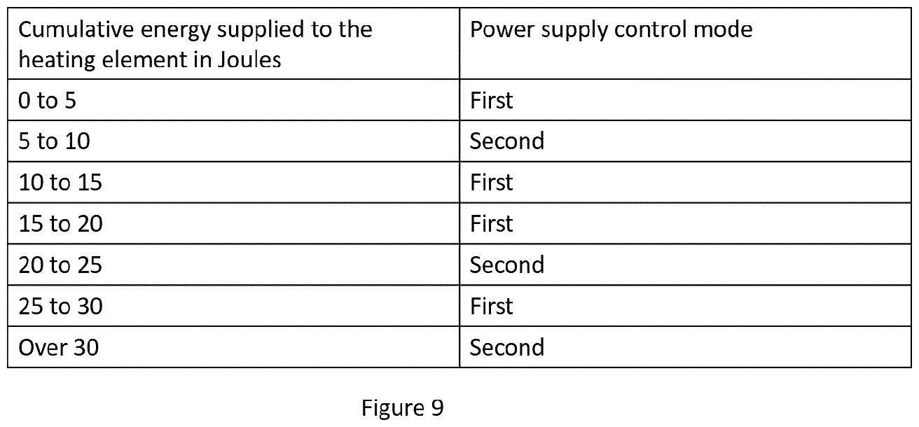

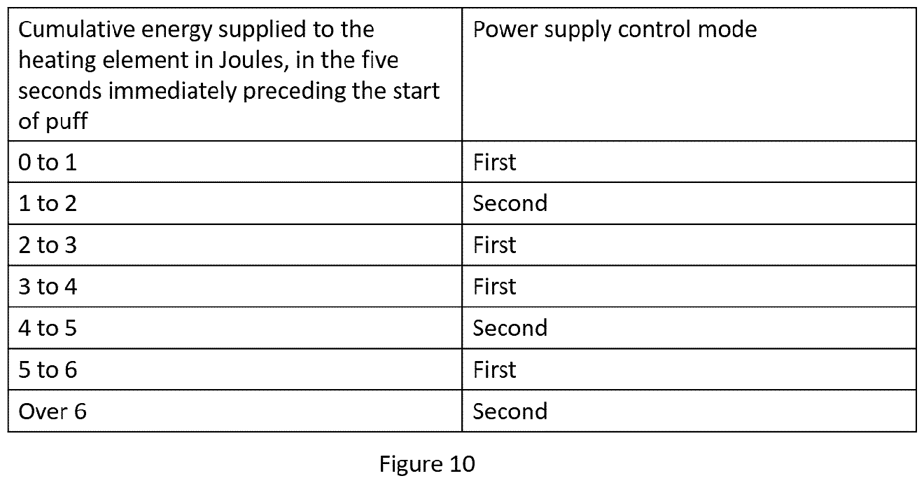

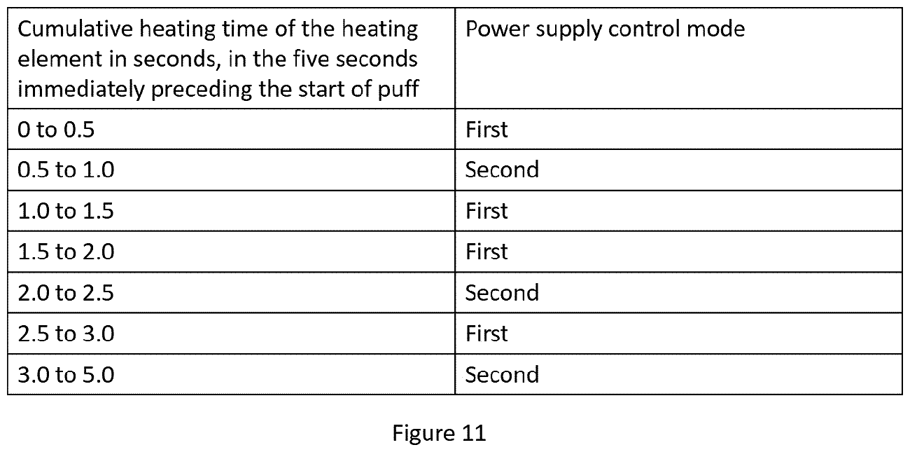

Alternative metrics to determine whether to control the supply of power to the heating element either in a first mode or a second mode may be used. These include depending on one or both of: the cumulative puffing time, or the cumulative energy supplied to the heating element since one of: the aerosol-generating system being reset, the aerosol-generating system being switched on, the heating element cooling down to an ambient temperature after at least one puff, or, in exemplary implementations in which the aerosol-generating system comprises an aerosol generating device, the aerosol generating device comprising a receptacle configured to receive an aerosol-generating article or a cartridge containing the aerosol-forming substrate, the aerosol-generating article or the cartridge being coupled to the aerosol-generating device. Example mode look-up tables for two of these alternative exemplary implementations are shown in FIGS. 8 and 9. Cumulative energy may be calculated by the controller from the current and voltage supplied to the heating element. Further alternative metrics include the controller being configured to control the supply of power to the heating element in either the first mode or the second mode dependent on a cumulative energy or a cumulative puffing time supplied to the heating element within a specified time interval prior to the start of the puff, with mode-look-up tables for such further alternatives shown in FIGS. 10 and 11.

In the first mode, the controller then controls the supply of power to the heating element based on ΔP and the elapsed time since the start of the puff at step 104. This is achieved by the controller using a look-up table stored in computer readable memory, an example of which is shown in FIG. 6. Each power value in the look-up table corresponds to both a range of ΔP, and a range of elapsed time since the start of the puff. The controller selects a power value from the look-up table to be supplied to the heating element using the calculated value of ΔP and the elapsed time since the start of the puff.

After a fixed time period, the controller reads a new value of the pressure measured by the sensor assembly at step 105. Using this new value of the pressure measured by the sensor assembly, the controller recalculates ΔP at step 106. If ΔP is greater than a second threshold pressure, the controller returns to step 104 to control the supply of power to the heating element based on ΔP.

If ΔP is less than or equal to the second threshold pressure, the controller stops power being supplied to the heating element, and returns to step 100 to read the pressure measured by the sensor assembly at regular time intervals. This is designated as the end of a puff, and the controller adds one to the number of puffs taken. In the second exemplary implementation also according to the invention in which the controller determines whether to control the supply of power to the heating element either in a first mode or a second mode depending on the cumulative puffing time, the controller instead adds the duration of the puff to the cumulative puffing time.

The time at which the aerosol-generating system designates the end of the puff is dependent on if ΔP is less than or equal to the second threshold pressure. The second threshold pressure is a predetermined proportion of the maximum ΔP determined by the controller since the start of the current puff. However, other events for designating the end of the puff may be used instead. For example, when ΔP is less than or equal to the threshold pressure, or when ΔP is less than or equal to a multiple of the threshold pressure.

In the second mode, the controller controls the supply of power to the heating element independent of ΔP and the elapsed time since the start of the puff in step 107. The power supplied to the heating element is a constant power, determined by the corresponding entry of a mode look-up table.

After a fixed time period, the controller reads a new value of the pressure measured by the sensor assembly in step 108. Using this new value of the pressure measured by the sensor assembly, the controller recalculates ΔP in step 109. If ΔP is greater than the second threshold pressure, the controller returns to step 107 to control the supply of power to the heating element based on ΔP.

If ΔP is less than or equal to the second threshold pressure, the controller stops power being supplied to the heating element, and returns to step 100, reading the pressure measured by the sensor assembly at regular time intervals. This is designated as the end of a puff, and the controller adds one to the number of puffs taken. In the second exemplary implementation also according to the invention in which the controller determines whether to control the supply of power to the heating element either in a first mode or a second mode depending on the cumulative puffing time, the controller instead adds the duration of the puff to the cumulative puffing time.

FIG. 4 is a flow diagram showing a method of detecting a puff and supplying power to a heating element in a first mode also according to the disclosure. The step of determining whether to control the supply of power to the heating element either in a first mode or a second mode is not included, and the controller only supplies power to the heating element the first mode. The method steps are otherwise identical to that set out with respect to FIG. 3.

FIG. 5 is a plot of an example puff profile, showing pressure difference against time elapsed since the start of the puff. The pressure difference is defined as being the difference between a reference pressure calculated by the controller and the pressure read by the controller from the sensor assembly. As the user puffs on the aerosol-generating system, pressure inside the system, and at the sensor, is reduced. The reduction in pressure at the sensor and read by the controller results in an increase in pressure difference calculated by the controller. Time is shown from the start of a puff as detected by the controller.

The puff profile shows an initial increase in pressure difference as the user begins to puff on the aerosol-generating system. The pressure difference increases linearly with time. The pressure difference then plateaus, and remains constant for a period of time as the user continues to draw on the aerosol-generating system. Pressure difference then decreases as the user begins to stop puffing on the aerosol-generating system. The time at which the aerosol-generating system designates the end of the puff is shown at point 201. The designation of the end of the puff at this point allows for the subsequent flushing of the aerosol-generating system, as the user continues to weakly puff on the aerosol-generating system, but no power is applied to the heating element.

The puff profile shown in FIG. 5 is an idealised puff profile, and the puff profile can vary in shape between users and between puffs. There may be more than one maxima of the pressure difference, and more than zero minima of the pressure difference. Additionally, the pressure difference may vary smoothly and non-linearly with time.

The plot shown in FIG. 5 is divided into ranges of pressure difference, and ranges of time elapsed since the start of the puff.

There are eight ranges of pressure difference. The first seven ranges of pressure difference are not equally spaced, and can be chosen to suit a puff profile, though it would be appreciated by a person skilled in the art that these pressure difference ranges may be equally spaced. The example ranges of pressure drop are as follows: Pressure Range one: 0 Pascal to 150 Pascal, Pressure Range two: 150 Pascal to 250 Pascal, Pressure Range three: 250 Pascal to 500 Pascal, Pressure Range four: 500 Pascal to 750 Pascal, Pressure Range five: 750 Pascal to 1000 Pascal, Pressure Range six: 1000 Pascal to 1750 Pascal, Pressure Range seven: 1750 Pascal to 2500 Pascal, Pressure Range eight: 2500 Pascal and above.

There are also six ranges of time elapsed since the start of the puff. The first five ranges of time elapsed since the start of the puff are equally spaced, though these pressure difference ranges may not be equally spaced, and can be chosen to suit a particular puff profile. The example ranges of time elapsed since the start of the puff are as follows: Time range one: 0 milliseconds to 700 milliseconds, Time range two: 700 milliseconds to 1400 milliseconds, Time range three: 1400 milliseconds to 2100 milliseconds, Time range four: 2100 milliseconds to 2800 milliseconds, Time range five: 2800 milliseconds to 3500 milliseconds, Time range six: 3500 milliseconds and above.

FIG. 6 is an example look-up table used by the controller to control the power supplied to the heating element in the first mode. The look-up table comprises a matrix of power values. The power of each power value is given in Watts. Each power value is associated with a pressure difference range and a range of time elapsed since the start of the puff. The pressure difference ranges and ranges of time elapsed since the start of the puff are identical to those described with respect to FIG. 5. In the first mode, determining module 81 determines the amount of power to supply to the heater element by comparing ΔP to the pressure difference ranges, and the elapsed time since the start of the puff to the ranges of time elapsed since the start of the puff. The user is able to change a system profile value stored in the controller. The change in the system profile value changes the power values stored in the look-up table to a different matrix of power values.

The look-up table may comprise a matrix of power profiles instead. Such power profiles are defined as power as a function of time. The power profiles may be flat, such that the amount of power determined by determining module 81 to supply to the heater element is constant for the duration of the regular time interval. In this case, the look-up table would result in substantially identical operation to use of the look-up table shown in FIG. 6. Alternatively however, the power profiles may be such that amount of power determined by determining module 81 to supply to the heater element varies with time during the regular time interval. The variation or power with time may be an increase or a decrease during the regular time interval, or the power may both increase and decrease at least once during the regular time interval. For example, for one power profile entry, the power may linearly increase from 5 Watts to 10 Watts for the first half of the regular time interval, before remaining constant at 10 Watts for the remainder of the regular time interval. Such increases or decreases may vary smoothly and continuously with time, or may be discontinuous. The matrix of power profiles may comprise a plurality of different power profiles.

FIG. 7 is an example mode look-up table which may be used by the controller to determine whether to control the supply of power to the heating element either in a first mode or a second mode according to an exemplary implementation. The selection is dependent on the number of puffs taken by the user. The first puff taken by the user after one of: the aerosol-generating system being reset, the aerosol-generating system being switched on, the heating element cooling down to an ambient temperature after at least one puff, or, in exemplary implementations in which the aerosol-generating system comprises an aerosol generating device, the aerosol generating device comprising a receptacle configured to receive an aerosol-generating article or a cartridge containing the aerosol-forming substrate, the aerosol-generating article or the cartridge being coupled to the aerosol-generating device, is taken to be puff number one. The controller records and reads the number of puffs taken by the user on the computer readable memory 85.

FIG. 8 is an alternative example mode look-up table which may be used by the controller to determine whether to control the supply of power to the heating element either in a first mode or a second mode according to an alternative exemplary implementation. The selection is dependent on the cumulative puffing time. The cumulative puffing time is set by the controller to zero seconds after one of: the aerosol-generating system being reset, the aerosol-generating system being switched on, the heating element cooling down to an ambient temperature after at least one puff, or in exemplary implementations in which the aerosol-generating system comprises an aerosol generating device, the aerosol generating device comprising a receptacle configured to receive an aerosol-generating article or a cartridge containing the aerosol-forming substrate, when the aerosol-generating article or the cartridge is coupled to the aerosol-generating device. The controller then records and reads the cumulative puffing time on the computer readable memory 85, using clock 84.

FIG. 9 is an alternative example mode look-up table which may be used by the controller to determine whether to control the supply of power to the heating element either in a first mode or a second mode according to a further alternative exemplary implementation. The selection is dependent on the cumulative energy supplied to the heating element. The cumulative energy supplied to the heating element is set by the controller to zero joules after one of: the aerosol-generating system being reset, the aerosol-generating system being switched on, the heating element cooling down to an ambient temperature after at least one puff, or, in exemplary implementations in which the aerosol-generating system comprises an aerosol generating device, the aerosol generating device comprising a receptacle configured to receive an aerosol-generating article or a cartridge containing the aerosol-forming substrate, the aerosol-generating article or the cartridge being coupled to the aerosol-generating device. The controller then records and reads the cumulative energy supplied to the heating element on the computer readable memory 85. The cumulative energy supplied to the heating element is calculated by the controller using the voltage and current supplied by the controller to the heating element. A combination of at least two of the parameters: a cumulative energy supplied to the heating element, a cumulative puffing time and a number of puffs may be used in place of any of the parameters alone. For example, a metric value may be defined as a number of puffs multiplied by a cumulative puffing time since one of: the aerosol-generating system being reset, the aerosol-generating system being switched on, the heating element cooling down to an ambient temperature after at least one puff, or, in exemplary implementations in which the aerosol-generating system comprises an aerosol generating device, the aerosol generating device comprising a receptacle configured to receive an aerosol-generating article or a cartridge containing the aerosol-forming substrate, the aerosol-generating article or the cartridge being coupled to the aerosol-generating device. The power may then supplied to the heater element in either the first mode or the second mode dependent on the value of the metric value.

FIGS. 10 and 11 are two alternative example mode look-up tables which may be used by the controller to determine whether to control the supply of power to the heating element either in a first mode or a second mode according to a further alternative exemplary implementation. The selections are dependent on the cumulative energy supplied to the heating element within a specified time interval prior to the start of the puff and the cumulative heating time of the heating element within a specified time interval prior to the start of the puff respectively. For example, as shown in FIGS. 10 and 11, the selections may be dependent on the cumulative energy supplied to the heating element and the cumulative heating time of the heating element within the five seconds immediately preceding the start of the puff respectively.

The described embodiments of the power control process are aerosol-generating systems comprising a cartridge containing a liquid aerosol-forming substrate and a resistively heated heater. However, the control processes described can be used in other types of aerosol-generating system on which a user puffs and so in which a variable airflow rate is encountered in use. For example, the aerosol-generating system may use inductive heating. The aerosol-generating system may also be a heat-not-burn system that heats a solid aerosol-forming substrate in an aerosol-generating article similar to a cigarette.

1.-15. (canceled)

16. An aerosol-generating system, comprising:
an air inlet and an air outlet;
an air flow passage extending between the air inlet and the air outlet;
a heating element configured to heat an aerosol-forming substrate;
a sensor assembly in communication with the air flow passage, the sensor assembly being configured to measure a pressure or a flow rate within the airflow passage; and
a controller configured to detect a start of a puff, read the pressure or the flow rate measured by the sensor assembly, and control a supply of power to the heating element in a first mode in response to the start of the puff,
wherein the controller controls the supply of power to the heating element in the first mode dependent on both a time since the start of the puff and the pressure or the flow rate read by the controller following the start of the puff, and
wherein the controller comprises a computer readable memory storing a look-up table, the look-up table comprising a plurality of power values, each power value corresponding to a pressure range or a flow rate range, and a time range since the start of a puff, and the controller is further configured in the first mode to use the look-up table to control the supply of power to the heating element.

17. The aerosol-generating system according to claim 16, wherein the controller is further configured in the first mode to read the pressure or the flow rate from the sensor assembly at regular time intervals.

18. The aerosol-generating system according to claim 16, wherein the supply of power to the heating element in the first mode is dependent on a difference between a reference pressure or a reference flow rate, and the pressure or the flow rate read by the controller.

19. The aerosol-generating system according to claim 18, wherein the controller detects the start of a puff when the difference between the reference pressure or the reference flow rate, and the pressure or the flow rate read by the controller exceeds a first threshold pressure or a first threshold flow rate.

20. The aerosol-generating system according to claim 18, wherein the reference pressure or the reference flow rate is calculated by the controller as a rolling average of an integer number of pressure values or flow rate values read by the controller preceding the detection of the start of the puff.

21. The aerosol-generating system according to claim 16,
wherein the controller is further configured to control the supply of power to the heating element in a second mode, and
wherein the supply of power to the heating element in the second mode is independent of at least one of the measured time since the start of a puff and the pressure or the flow rate read by the controller.

22. The aerosol-generating system according to claim 21, wherein in the second mode the power supplied to the heating element is constant for a duration of a puff.

23. The aerosol-generating system according to claim 21, wherein the controller is further configured to control the supply of power to the heating element in either the first mode or the second mode dependent on a number of puffs since one of: the aerosol-generating system being reset, the aerosol-generating system being switched on, or the heating element cooling down to an ambient temperature after at least one puff.

24. The aerosol-generating system according to claim 21, wherein the controller is further configured to control the supply of power to the heating element in either the first mode or the second mode dependent on a cumulative puffing time since one of: the aerosol-generating system being reset, the aerosol-generating system being switched on, or the heating element cooling down to an ambient temperature after at least one puff.

25. The aerosol-generating system according to claim 21,
further comprising an aerosol generating device, the aerosol generating device comprising a receptacle configured to receive an aerosol-generating article or a cartridge containing the aerosol-forming substrate,
wherein the aerosol-generating article or the cartridge can be coupled to and uncoupled from the aerosol-generating device.

26. The aerosol-generating system according to claim 25, wherein the controller is further configured to control the supply of power to the heating element in either the first mode or the second mode dependent on a number of puffs since the aerosol-generating article or the cartridge has been coupled to the aerosol-generating device.

27. The aerosol-generating system according to claim 25, wherein the controller is further configured to control the supply of power to the heating element in either the first mode or the second mode dependent on a cumulative puffing time since the aerosol-generating article or the cartridge has been coupled to the aerosol-generating device.

28. A method of aerosol production in an aerosol generating system,
the system comprising:
an air flow passage extending between an air inlet and an air outlet,
a heating element configured to heat an aerosol-forming substrate,
a sensor assembly in communication with the air flow passage, and
a controller comprising a computer readable memory storing a look-up table, the look-up table comprising a plurality of power values, each power value corresponding to a pressure range or a flow rate range, and a time range since the start of a puff; and
the method comprising, in a first mode:
detecting a start of a puff,
reading an output from the sensor assembly to determine a pressure or a flow rate in the airflow passage,
selecting a power value from a look up table stored in the computer readable memory based on the pressure or the flow rate in the airflow passage and a time since the start of the puff, and
supplying the heating element with power dependent on both a time since the start of the puff and the pressure or the flow rate in the airflow passage and based on the selected power value.

29. The method of aerosol production in an aerosol generating system according to claim 28, wherein in the first mode the output from the sensor assembly is read at regular time intervals.
